(19) United States
(12) Patent Application Publication
(10) Pub. No.: US 2024/0283692 A1
(43) Pub. Date: Aug. 22, 2024

(54) TRANSMITTING DATA VIA A FRONTHAUL INTERFACE WITH ADJUSTABLE TIMING

(71) Applicant: NOKIA SOLUTIONS AND NETWORKS OY, Espoo (FI)

(72) Inventors: Peter SKOV, Valby (DK); Eero Vilho Juhani RYYTTY, Oulu (FI); Krzysztof KURNICKI, Wroclaw (PL)

(21) Appl. No.: 18/570,329

(22) PCT Filed: Jun. 15, 2022
(86) PCT No.: PCT/EP2022/066287

§ 371 Date: Dec. 14, 2023

(30) Foreign Application Priority Data
Jun. 16, 2021 (FI) 20215711

(51) Int. Cl. H04L 27/26; H04J 3/06; H04L 47/28

(52) U.S. Cl. CPC H04L 27/2666; H04J 3/0658; H04L 47/28

(57) ABSTRACT

Disclosed is a method comprising processing a first set of data, assigning the first set of data to a first timing group comprising a first transmission time window, transmitting the first set of data via a fronthaul interface during the first transmission time window, processing a second set of data, wherein at least a part of the second set of data is processed during the first transmission time window, assigning the second set of data to a second timing group comprising a second transmission time window, and transmitting the second set of data via the fronthaul interface during the second transmission time window.

### FIELD

The following exemplary embodiments relate to wireless communication.

### BACKGROUND

As resources are limited, it is desirable to optimize the usage of network resources. A base station may be utilized to improve the performance of the base station and thus enable better usage of resources.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: process a first set of data; assign the first set of data to a first timing group comprising a first transmission time window; transmit the first set of data via a fronthaul interface during the first transmission time window; process a second set of data, wherein at least a part of the second set of data is processed during the first transmission time window; assign the second set of data to a second timing group comprising a second transmission time window; and transmit the second set of data via the fronthaul interface during the second transmission time window.

According to another aspect, there is provided an apparatus comprising means for: processing a first set of data; assigning the first set of data to a first timing group comprising a first transmission time window; transmitting the first set of data via a fronthaul interface during the first transmission time window; processing a second set of data, wherein at least a part of the second set of data is processed during the first transmission time window; assigning the second set of data to a second timing group comprising a second transmission time window; and transmitting the second set of data via the fronthaul interface during the second transmission time window.

According to another aspect, there is provided a method comprising processing a first set of data; assigning the first set of data to a first timing group comprising a first transmission time window; transmitting the first set of data via a fronthaul interface during the first transmission time window; processing a second set of data, wherein at least a part of the second set of data is processed during the first transmission time window; assigning the second set of data to a second timing group comprising a second transmission time window; and transmitting the second set of data via the fronthaul interface during the second transmission time window.

According to another aspect, there is provided a computer program comprising instructions for causing an apparatus to perform at least the following: process a first set of data; assign the first set of data to a first timing group comprising a first transmission time window; transmit the first set of data via a fronthaul interface during the first transmission time window; process a second set of data, wherein at least a part of the second set of data is processed during the first transmission time window; assign the second set of data to a second timing group comprising a second transmission time window; and transmit the second set of data via the fronthaul interface during the second transmission time window.

According to another aspect, there is provided a computer readable medium comprising program instructions for causing an apparatus to perform at least the following: process a first set of data; assign the first set of data to a first timing group comprising a first transmission time window; transmit the first set of data via a fronthaul interface during the first transmission time window; process a second set of data, wherein at least a part of the second set of data is processed during the first transmission time window; assign the second set of data to a second timing group comprising a second transmission time window; and transmit the second set of data via the fronthaul interface during the second transmission time window.

According to another aspect, there is provided a non-transitory computer readable medium comprising program instructions for causing an apparatus to perform at least the following: process a first set of data; assign the first set of data to a first timing group comprising a first transmission time window; transmit the first set of data via a fronthaul interface during the first transmission time window; process a second set of data, wherein at least a part of the second set of data is processed during the first transmission time window; assign the second set of data to a second timing group comprising a second transmission time window; and transmit the second set of data via the fronthaul interface during the second transmission time window.

According to another aspect, there is provided an apparatus comprising at least one processor, and at least one memory including computer program code, wherein the at least one memory and the computer program code are configured, with the at least one processor, to cause the apparatus to: assign a first set of data to a first transmission time window; adjust the first transmission time window by applying a first scaling factor to the first transmission time window; and transmit the first set of data via a fronthaul interface during the adjusted first transmission time window.

According to another aspect, there is provided an apparatus comprising means for: assigning a first set of data to a first transmission time window; adjusting the first transmission time window by applying a first scaling factor to the first transmission time window; and transmitting the first set of data via a fronthaul interface during the adjusted first transmission time window.

According to another aspect, there is provided a method comprising assigning a first set of data to a first transmission time window; adjusting the first transmission time window by applying a first scaling factor to the first transmission time window; and transmitting the first set of data via a fronthaul interface during the adjusted first transmission time window.

According to another aspect, there is provided a computer program comprising instructions for causing an apparatus to perform at least the following: assign a first set of data to a first transmission time window; adjust the first transmission time window by applying a first scaling factor to the first transmission time window; and transmit the first set of data via a fronthaul interface during the adjusted first transmission time window.

According to another aspect, there is provided a computer readable medium comprising program instructions for causing an apparatus to perform at least the following: assign a first set of data to a first transmission time window; adjust the first transmission time window by applying a first scaling factor to the first transmission time window; and transmit the first set of data via a fronthaul interface during the adjusted first transmission time window.

According to another aspect, there is provided a non-transitory computer readable medium comprising program instructions for causing an apparatus to perform at least the following: assign a first set of data to a first transmission time window; adjust the first transmission time window by applying a first scaling factor to the first transmission time window; and transmit the first set of data via a fronthaul interface during the adjusted first transmission time window.

According to another aspect, there is provided a system comprising at least a radio unit and a distributed unit. The radio unit is configured to: process a first set of data; assign the first set of data to a first timing group comprising a first transmission time window; transmit the first set of data to the distributed unit via a fronthaul interface during the first transmission time window; process a second set of data, wherein at least a part of the second set of data is processed during the first transmission time window; assign the second set of data to a second timing group comprising a second transmission time window; and transmit the second set of data via the fronthaul interface during the second transmission time window. The distributed unit is configured to: receive the first set of data via the fronthaul interface; and receive the second set of data via the fronthaul interface.

According to another aspect, there is provided a system comprising at least a radio unit and a distributed unit. The radio unit comprises means for: processing a first set of data; assigning the first set of data to a first timing group comprising a first transmission time window; transmitting the first set of data to the distributed unit via a fronthaul interface during the first transmission time window; processing a second set of data, wherein at least a part of the second set of data is processed during the first transmission time window; assigning the second set of data to a second timing group comprising a second transmission time window; and transmitting the second set of data via the fronthaul interface during the second transmission time window. The distributed unit comprises means for: receiving the first set of data via the fronthaul interface; and receiving the second set of data via the fronthaul interface.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates a simplified exemplary embodiment of a base station;

FIG. 3 illustrates a simplified open radio access network base station architecture;

FIG. 4 illustrates a flow chart according to an exemplary embodiment;

FIG. 5 illustrates an example showing the impact of a transmission window scaling factor;

FIGS. 6-7 illustrate flow charts according to some exemplary embodiments;

FIGS. 8a-8d illustrate examples of timing groups;

FIG. 9 illustrates a flow chart according to an exemplary embodiment;

FIG. 10 illustrates an apparatus according to an exemplary embodiment.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

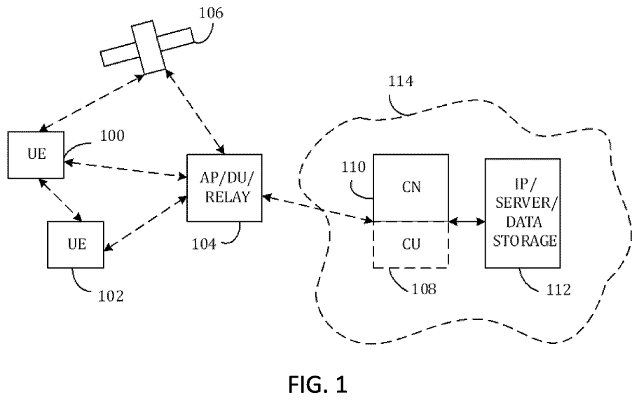

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g) NodeB may be called uplink or reverse link and the physical link from the (e/g) NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G may enable using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz—cmWave, below 6 GHz—cmWave—mmWave). One of the concepts considered to be used in 5G networks may be network slicing in which multiple independent and dedicated virtual sub-networks (network instances) may be created within the same infrastructure to run services that have different requirements on latency, reliability, throughput and mobility.

The current architecture in LTE networks may be fully distributed in the radio and fully centralized in the core network. The low latency applications and services in 5G may require to bring the content close to the radio which leads to local break out and multi-access edge computing (MEC). 5G may enable analytics and knowledge generation to occur at the source of the data. This approach may require leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a centralized unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home(e/g)nodeB.

Furthermore, the (e/g)nodeB or base station may also be split into: a radio unit (RU) comprising a radio transceiver (TRX), i.e. a transmitter (TX) and a receiver (RX); a distributed unit (DU) that may be used for the so-called Layer 1 (L1) processing and real-time Layer 2 (L2) processing; and a centralized unit (CU) or a central unit that may be used for non-real-time L2 and Layer 3 (L3) processing. Such a split may enable the centralization of CUs relative to the cell sites and DUs, whereas DUs may be more distributed and may even remain at cell sites. The CU and DU together may also be referred to as baseband or a baseband unit (BBU). The RU and DU may also be comprised into a radio access point (RAP). Cloud computing platforms may also be used to run the CU or DU. The CU may run in a cloud computing platform (vCU, virtualized CU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be required to provide such a network structure.

For fulfilling the need for improving the deployment and performance of communication systems, the concept of “plug-and-play” (e/g)NodeBs may be introduced. A network which may be able to use “plug-and-play” (e/g)Node Bs, may include, in addition to Home (e/g)NodeBs (H(e/g)nodeBs), a home node B gateway, or HNB-GW (not shown in FIG. 1). A HNB Gateway (HNB-GW), which may be installed within an operator's network, may aggregate traffic from a large number of HNBs back to a core network.

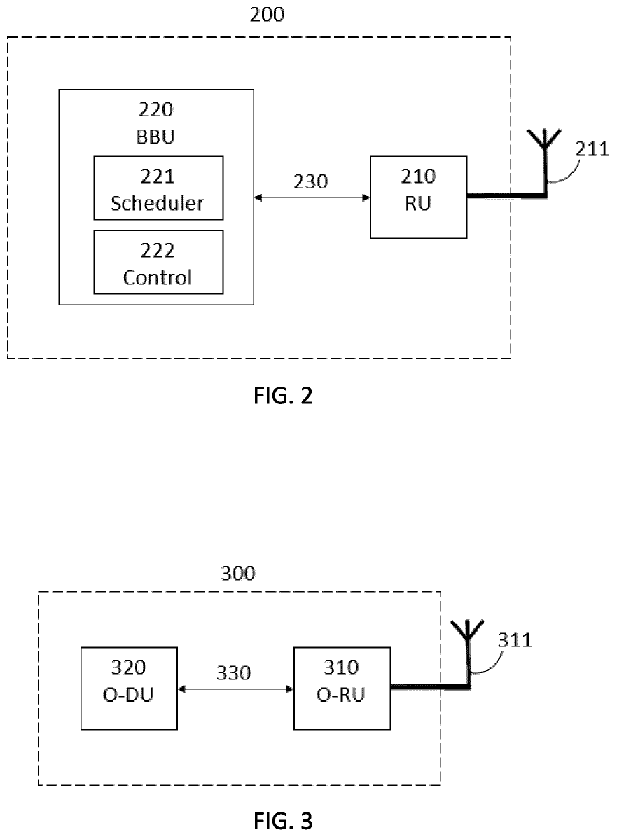

FIG. 2 illustrates a simplified exemplary embodiment of a base station 200. It is obvious for a person skilled in the art that the base station may deviate from what is depicted in FIG. 2. The base station comprises a radio unit 210, RU, which may also be referred to as a radio head. The RU may comprise radio frequency transmitter and receiver components for radio communication with one or more terminal devices, for example. The RU may comprise a low noise amplifier, which amplifies a received signal that has been attenuated in a radio path. A receiver may down-convert the received signal to an intermediate frequency and then to a baseband frequency, or directly to the baseband frequency. In a transmitter, the signal may be up-converted to a carrier frequency and amplified with a transmit power amplifier. The RU may also comprise an analog-to-digital and/or digital-to-analog converter. The RU may be connected to one or more antennas 211. A transceiver may use the same antenna for receiving and transmitting, and therefore there may also be a duplex filter to separate transmission and reception. Separate antennas may also be used for transmission and reception. The antenna may be an antenna array or a single antenna. The RU may also perform other radio frequency processing functions.

In the exemplary embodiment of FIG. 2, additional functions of the base station are comprised in a baseband unit 220 (BBU) that may be used for processing baseband. The BBU and the RU are connected via a fronthaul interface 230. The fronthaul interface 230 may comprise an optical fiber connection and it may be based on, for example, the common public radio interface (CPRI) protocol, or the ethernet-based eCPRI protocol by CPRI forum, or another ethernet-based fronthaul interface. The BBU may be implemented, for example, with one or more ASICs (application specific integrated circuits) and/or other components. The BBU may perform, for example, digital signal processing (DSP) functions, such as coding and decoding. The BBU may comprise a DSP block for DSP processing and/or a CPU block (central processing unit). The BBU may further comprise a memory unit or be connected to a memory unit. The memory may be implemented using any suitable data storage technology, such as semiconductor-based memory devices, flash memory, magnetic memory devices and systems, optical memory devices and systems, fixed memory and removable memory. In this exemplary embodiment, the BBU comprises a scheduler 221 that is configured to schedule the transmission of signals. The control block 222 that, in this exemplary embodiment, is comprised in the BBU, may control transmission and reception of signals.

An open radio access network, O-RAN, refers to a concept based on interoperability of RAN elements between different vendors over a set of defined interfaces. Thus, O-RAN enables baseband unit and radio unit components from different vendors to operate together.

FIG. 3 illustrates a simplified O-RAN base station architecture. In O-RAN, a base station 300 comprises two main nodes, which are the O-RAN distributed unit 320 (O-DU) and the O-RAN radio unit 310 (0-RU). The O-DU and the O-RU are connected by a fronthaul interface 330, which may use the eCPRI protocol, for example. The fronthaul interface 330 may comprise an optical fiber connection, for example.

The O-DU 320 is a logical node hosting for example the RLC (radio link control), MAC (medium access control), and high-PHY layers. The O-DU may handle digital signal processing and baseband processing, and it may also control the operation of the O-RU.

The O-RU 310 is a logical node hosting for example the low-PHY layer and radio frequency processing. The O-RU may connect one or more terminal devices to the O-RAN. In the downlink direction, the O-RU processes data received from the O-DU 320 via the fronthaul interface 330, and outputs IQ data as a radio frequency signal via an antenna 311. In the uplink direction, the O-RU receives a radio frequency signal via the antenna 311, processes the radio frequency signal, and outputs data to the O-DU 320 via the fronthaul interface 330. It should be noted that the O-RAN base station may comprise one or more O-RUs.

The openness of O-RAN also extends to the fronthaul interface. However, openness of the network may require a strict synchronization and timing mechanism, such as precision time protocol (PTP), between the O-DU and O-RU in order to ensure proper transmission and reception of data packets over the fronthaul interface.

Transmission delay between the O-DU and O-RU may be specified by an amount of time T12 in the downlink and an amount of time T34 in the uplink. The transmission delay may be defined as the time interval from when a bit leaves the sender node until it is received at the receiving node. These delays may not be constant for example due to switching delays, and thus the transmission delay may be considered as a range with upper and lower limits, in which the delay is tolerable. The downlink transmission delay limits may be defined by parameters T12min and T12max, while the uplink transmission delay limits may be defined by parameters T34min and T34max. It should be noted that timing may be fixed at the antenna interface of the O-RU. Therefore, the antenna interface may be used as a reference point for delay management for example in the eCPRI model. In other words, transmission and reception at the reference points of the O-DU and O-RU may be measured relative to the antenna interface. This results in the parameters depicted in Table 1 below.

TABLE 1

| | | Param- | | Mini- | Maxi- |
|---|---|---|---|---|---|
| Direction | Node | eter | Latency | mum | mum |
| Downlink | O-DU | T1a | Measured from | T1amin | T1amax |
| | | | output at O-DU | | |
| | | | to transmission | | |
| | | | over the air. | | |
| | O-RU | T2a | Measured from | T2amin | T2amax |
| | | | reception at O-RU | | |
| | | | to transmission | | |
| | | | over the air. | | |
| Uplink | O-DU | Ta4 | Measured from | Ta4min | Ta4max |
| | | | reception at | | |
| | | | O-RU antenna to | | |
| | | | reception at | | |
| | | | O-DU port. | | |
| | O-RU | Ta3 | Measured from | Ta3min | Ta3max |
| | | | reception at | | |
| | | | O-RU antenna to | | |
| | | | output at | | |
| | | | O-RU port. | | |

Since it takes some amount of time to transmit packet data in the O-RAN fronthaul, the receiving node may buffer the packets in which symbol data is encapsulated. However, the time of buffering may vary, since the duration of the symbol may depend on parameters such as subcarrier spacing (SCS). Therefore, a time window may be defined to limit this buffering time and the time of data transmission between the O-DU and O-RU. Table 2 below depicts the eCPRI delay windows.

TABLE 2

| | Reception | Transmission | Transport |
|---|---|---|---|
| Direction | window | window | variation |
| Downlink | T2amax-T2amin | T1amax-T1amin | T12max-T12min |
| Uplink | Ta4max-Ta4min | Ta3max-Ta3min | T34max-T34min |

The transmission window defines the maximum amount of time allowed for the transmitting node to send data for an interval. In the downlink direction, the transmission window may be set by the O-DU based on O-RU buffering characteristics. The downlink transmission window may be defined as the range between the timing parameters T1amax and T1amin.

To account for transport variation and transmission delay, the receiving node implements a reception window. This allows packets comprising samples for a specific symbol to be received within the reception window, and still be transmitted at the antenna interface at the required time. Since the O-RU is the recipient in downlink, it may buffer the packets arriving from the O-DU within the reception window. The downlink reception window may be defined as the range between the timing parameters T2amax and T2amin. T2amax may be the earliest time when the O-RU starts buffering the data packets, and the packets may then be buffered until T2amin, which may represent the minimum time that a packet needs to reach the O-RU. After that time, the packets may be discarded. T2amin may be defined as the time when the O-RU starts processing the arrived or buffered packets.

In the uplink direction, the transmission window is in the O-RU. The transmission window limits are Ta3min and Ta3max. Ta3min is the earliest time to transmit the packet to the O-DU, while Ta3max represents the end of the transmission. The packets may be delayed by a variable time value between T34min and T34max.

The uplink reception window in the O-DU should accept the arrived packets. The reception window may be defined as the range between the timing parameters Ta4max and Ta4min.

The O-DU should set the transmission window in downlink and the reception window in uplink to be large enough, so that all transmitted packets arrive within the reception window. For determining the windows, the O-DU may use the O-RU delay characteristics, i.e. T2amin and T2amax for downlink as well as Ta3min and Ta3max for uplink, and the transport network delay characteristics, i.e. T12min and T12max in the downlink direction as well as T34min and T34max for uplink. The accuracy of the O-RU delay characteristics may be approximately 200 ns.

In the downlink direction, in order to ensure that the packets sent from the O-DU do not arrive before T2amax, it may be beneficial if T1amax is less than or equal to T2amax+T12min, which represents the earliest scenario. It may also be beneficial to set T1amin as greater than or equal to T2amin+T12max, i.e. early enough to ensure that packets are received before the processing start time T2amin of the O-RU. In the uplink direction, the O-DU may align the reception window such that Ta4min is less than or equal to T3amin+T34min, which represents the fastest path for packets to be received, i.e. early enough to be able to receive from the earliest possible moment when the packets may arrive. It may be beneficial to set T4amax as greater than or equal to Ta3max+T34max, i.e. late enough to ensure that all the packets are received even when some packets are late.

The delay parameters above describe the general delay model and characteristics of the O-RAN fronthaul interface. However, the O-RAN fronthaul interface is divided into a control plane and a user plane. The control plane comprises the configurations to prepare the O-RU for user plane processing. Since the control plane needs to be available in order to process the corresponding user plane packets, control plane messages should arrive in advance of the corresponding user plane messages by an amount of time defined by a timing parameter Tcp_adv_dl. In other words, control plane messages may be shifted earlier in time by the timing parameter Tcp_adv_dl with respect to the user plane messages. The transmission windows of the control plane and user plane may be substantially the same size, or they may be different sizes.

In the downlink direction, the start of the transmission window for the control plane is represented by Tla_max_cp_dl. This time value represents the earliest case, when the O-DU starts transmitting a control plane packet. The end of the transmission window for the control plane may be defined by Tla_min_cp_dl. After this time, no packet of the specific symbol may be sent, since there is a risk that it may be received late, i.e. outside the reception window of the O-RU. The control plane packets may be delayed by a fronthaul transmission delay, which may vary between T12_max and T12_min. The transmission window may be set such that it ensures packets arriving within the O-RU reception window.

The reception window for the control plane in the downlink direction may start at substantially the same time as the transmission window. T2a_max_cp_dl represents the start of the reception window, i.e. the earliest time that the O-RU accepts control plane packets coming from the O-DU. Packets received after this time and before the end of the reception window may be buffered to wait for the O-RU processing to start. T2a_min_cp_dl represents the end of the reception window, and no control packets may be accepted after that time. It is also the point in time, when the O-RU starts processing the control plane packets. The control plane data may set specific parameters and update the module configuration such that the O-RU is prepared to process the coming user plane packets of a symbol.

In the downlink direction, the start of the O-DU transmission window for the user plane may be defined by T1a_max_up. T1a_min_up represents the end of the user plane transmission window, so that no user plane packets may be sent after this time. Similar to the control plane, the user plane packets may be delayed by a fronthaul transport delay defined by the range between T12_max and T12_min. Whatever the fronthaul path taken, the user plane packets should arrive within the reception window.

The O-RU reception window for the user plane starts at T2a_max_up, when the earliest packets can be accepted. The packets are buffered until the O-RU processing time begins. After that time, i.e. the end of the reception window defined by T2a_min_up, no user plane packets are accepted.

To ensure proper transmission and reception in the network, the O-DU may set the O-RU reception window range to be greater than the sum of the O-DU transmission window and the fronthaul transport delay. T12min may be determined to be the shortest transmission path based on the network configuration, including fiber delay in addition to switching delay. In addition, the longest fiber and switching delays may be presented on the time delay parameter T12_max. T2a_min represents the fixed processing time of the O-RU, and T2a_max represents the maximum buffering capability of the O-RU.

In the uplink direction, the control plane may be sent from the O-DU to the O-RU with similar rules as in the downlink direction. However, the transmission window and reception window characteristics may be different.

In the uplink direction, the control plane transmission window may be defined by a starting time T1a_max_cp_ul and an ending time T1a_min_cp_ul. The control plane reception window may be defined by a starting time T2a_max_cp_ul and an ending time T2a_min_cp_ul. The parameters T12_max and T12_min having the same direction may be shared between both downlink and uplink control planes.

The user plane is sent from the O-RU to the O-DU. Ta3_min denotes the start of the user plane transmission window located in the O-RU. Ta3_min may be defined as the earliest time that the O-RU can send user plane data for a specific symbol. The ending time of the transmission window in the uplink direction, i.e. Ta3_max, may define the latest time that the O-RU can send user plane data for a specific symbol. The packets may be delayed when coming out from the O-RU toward the O-DU by an uplink fronthaul transport delay defined by T34_min for the minimum delay and T34_max for the maximum delay.

The start of the user plane reception window in the O-DU may be defined by Ta4_min, which may indicate the earliest time that the O-DU can accept a user plane uplink data packet. As packets arrive after the beginning of the reception window, they may be buffered to wait for the O-DU processing to start. The end of the reception window may be the last time when the O-DU accepts user plane packets. The end of the user plane reception window may be defined by Ta4_max, which indicates the starting time of data processing in the O-DU. To ensure proper transmission and reception in the network, the O-RU reception window range may be set to be greater than the sum of the O-DU transmission window and the fronthaul uplink transport delay. The reception window at the O-DU should be large enough to accept the packets coming from the O-RU.

The O-DU transmission and reception windows may be determined based on pre-defined transport network characteristics, and the delay characteristics of the O-RU(s) within the timing domain. Therefore, the O-RU delay characteristics should be made available to the O-DU. The O-DU may then adapt its transmission and reception windows to accommodate the O-RU delay characteristics. Optionally, the O-RU may adapt its delay profile information, for example for uplink, based on the O-DU delay profile and transport delay. In this case, the O-DU should provide its delay profile as well as T12_min to the O-RU.

Delay characteristics for an O-RU may vary based on air interface properties. To ensure interoperability, the air interface properties supported by O-RAN, which may be used as the basis for supporting different delay characteristics, are currently limited to channel bandwidth and SCS. In other words, currently different delay characteristics cannot be applied to different carriers, if the carriers have substantially the same channel bandwidth and SCS.

A set of delay characteristics, which applies to a combination of the above properties, may be referred to as a delay profile. For each supported combination of the above properties that an O-RU supports, a delay profile may be identified. It may be possible for multiple combinations of the above properties to utilize the same O-RU delay profile. These delay profiles may be O-RU specific.

When calculating the O-DU transmission and reception window for a timing domain, the O-DU may use the delay profile applicable for a specific O-RU based on the air interface properties used by the O-RU in the specific network configuration. The O-RU and O-DU may have multiple delay profiles depending on the design. Table 3 below depicts the contents of various delay profiles. T1a_max_up_{O-DU} denotes the maximum supported T1a_max_up at the O-DU, and it may be greater than or equal to T1a_max_up. TXmax_{O-DU} denotes the maximum required transmission window at the O-DU, and it may be less than or equal to T1a_max_up−T1a_min_up. Ta4_max_{O-DU} denotes the maximum supported uplink latency at the O-DU relative to the antenna interface, and it may be greater than or equal to Ta4_max. RXmax_{O-DU} denotes the maximum supported reception window at the O-DU, and it may be greater than or equal to Ta4_max−Ta4_min.

TABLE 3

| Direction | O-RU delay profile | O-DU delay profile |
|---|---|---|
| Downlink | T2a_min_up, | T1a_max_up_{O-DU}, |
| | T2a_max_up, | TXmax_{O-DU} |
| | T2a_min_cp_dl, | |
| | T2a_max_cp_dl, | |
| | Tcp_adv_dl | |
| Uplink | Ta3_min, | Ta4ₘₐₓ_{_{O-DU}}, |
| | Ta3_max, | RXmax_{O-DU} |
| | T2a_min_cp_ul, | |
| | T2a_max_cp_ul | |

In order to improve system performance, uplink channel estimation and interference rejection combining may be included in some massive MIMO radio units. However, in a multi-carrier O-RU, processing of channel estimation for all the carriers, antennas and physical resource blocks (PRBs) may take a significant amount of time. With legacy O-RAN fronthaul timing principles, data transfer towards the system module, for example O-DU, may not be started until all channel estimation is completed, and the first symbol of data is available from all carriers.

In some cases, reuse of an existing O-RAN fronthaul timing definition may lead to a processing delay in the radio unit, which may not meet the hybrid automatic repeat request (HARQ) loop constraints, and may thus possibly lead to performance degradation in terms of increased user plane latency and reduced peak rate.

According to the legacy O-RAN fronthaul timing principles, carriers with the substantially same channel bandwidth and SCS may be required to apply the same delay profile. This may not allow for adapting timing parameters for different carriers such that data that is available from the L1 (layer 1) processor earlier would be transferred earlier.

Some exemplary embodiments may allow for more flexible configuration of fronthaul timing for example in O-RAN, so that transmission towards the system module, such as an O-DU, may start before all data from all carriers is available. For example, if data from a first cell is available earlier than data from a second cell, then the data from the first cell may be transferred earlier than the data from the second cell, instead of having to wait until all data from all cells is available. However, it should be noted that some exemplary embodiments are not limited to O-RAN. For example, some exemplary embodiments may be used with a virtualized radio access network (VRAN). With a VRAN, BBUs may be moved away from the base station to a data center. As a result, functions of the BBUs can be implemented with virtual machines in a centralized data center.

In some exemplary embodiments, a radio unit may indicate, or advertise, a capability of using a plurality of timing groups, wherein transmission and reception time windows may be defined independently per timing group. The capability may be indicated to the system module, such as an O-DU. Extended antenna-carriers (eAxC) may then be assigned to the timing groups in order to follow the transmission and reception time windows defined in the timing groups. eAxC may be defined as a data flow for a single antenna or spatial stream for a single carrier in a single sector. One eAxC may represent the amount of digital baseband (IQ) user plane data necessary for either reception or transmission of one carrier at one independent antenna element.

The mapping to timing groups may be constrained so that not all eAxCs are allowed to be assigned to the earliest timing group. The radio unit may define how many PRBs can be processed per timing group. Depending on the specific radio unit implementation, the earliest timing group may not be able to handle all PRBs from wide carrier sizes.

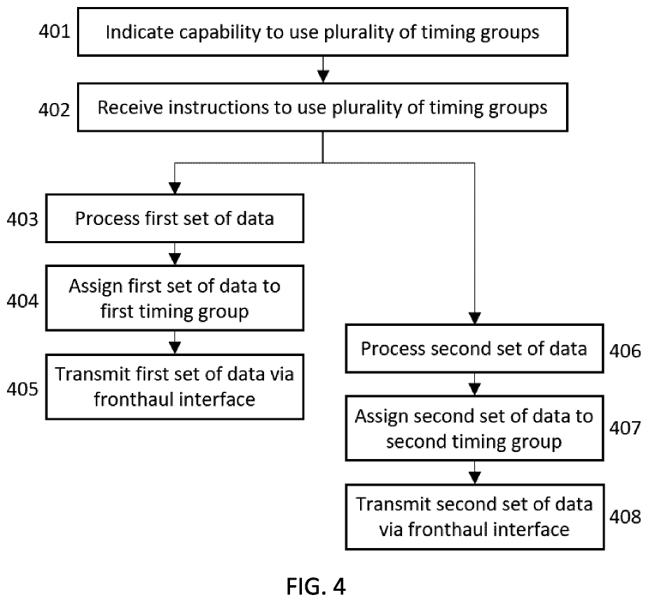

FIG. 4 illustrates a flow chart according to an exemplary embodiment. Referring to FIG. 4, a capability to use a plurality of timing groups comprising at least a first timing group and a second timing group is indicated 401 to a system module, such as an O-DU or a BBU, via a fronthaul interface. Instructions to use the plurality of timing groups is received 402 from the system module via the fronthaul interface. A first set of data is processed 403. For example, the first set of data may comprise uplink data associated with a first cell that is received via an antenna interface. The processing may comprise, for example, at least performing channel estimation and/or interference rejection combining. The first set of data is assigned 404 to the first timing group comprising a first transmission time window. For example, a first eAxC associated with the first set of data may be assigned to the first timing group. The first set of data is transmitted 405 to the system module, for example the O-DU or BBU, via the fronthaul interface during the first transmission time window.

A second set of data is processed 406, wherein at least a part of the second set of data is processed during the first transmission time window. In other words, the first set of data may finish processing earlier than the second set of data and thus the first set of data is available earlier, in which case the second set of data is still being processed when starting to transmit the first set of data. For example, the second set of data may comprise uplink data associated with a second cell that is received via the antenna interface. The second set of data is assigned 407 to a second timing group comprising a second transmission time window. For example, a second eAxC associated with the second set of data may be assigned to the second timing group. The second set of data is transmitted 408 to the system module, for example the O-DU or BBU, via the fronthaul interface during the second transmission time window. The first transmission window and the second transmission time window may overlap at least partially, or they may be completely separate from one another.

There may be additional latency considerations for example for category C O-RUs that are carrying out interference rejection combining and channel estimation. Since the additional processing takes additional time, the O-RU latency is increased. To optimize system performance, it is thus beneficial to minimize the time during which data is buffered in the O-RU. For this purpose, the O-RU may provide different delay characteristics for different carriers depending on the availability of O-RU processing resources and the channel estimation reference signal configuration. These carriers may even have the same SCS and bandwidth.

In an exemplary embodiment, the O-RU reports Ta3_min and Ta3_max at startup to the O-DU, if no interference rejection combining is configured. In case interference rejection combining is configured, the transmit window(s) are then adjusted by adding an endpoint-specific offset CombineTxWinShift. To further improve system efficiency, the O-RU may indicate a supported transmission window scaling factor CombineTxWinScale allowing for faster transfer of all data related to a certain slot. CombineTxWinScale may be ≤1. When CombineTxWinScale=1, legacy behavior is recovered.

$$Tx\_win \_start \_for \_symbol \_ n = Symbol\_ 0 \_air \_time \_start + Ta 3\_min + CombineTxWinShift + CombineTxWinScale * n * symbol\_duration$$

$$Tx\_win \_end \_for \_symbol \_ n = Symbol\_ 0 \_air \_time \_start + Ta 3 \_min + CombineTxWinShift + CombineTxWinScale * ( Ta 3 \_max - Ta 3 \_min ) + CombineTxWinScale * n * symbol\_duration$$

where Tx_win_start_for_symbol_n is the starting time of the transmission window for symbol n (n≥1), Symbol_0_air_time_start is the air time start of symbol 0, symbol_duration is the symbol duration, and Tx_win_end_for_symbol_n is the ending time of the transmission window for symbol n. Ta3_min denotes the start of the user plane transmission window located in the O-RU. Ta3_max denotes the ending time of the transmission window in the uplink direction, i.e. the latest time that the O-RU can send user plane data for the symbol. It should be noted that if CombineTxWinScale<1, then this may lead to a gap between slots, where the endpoint is not transmitting anything.

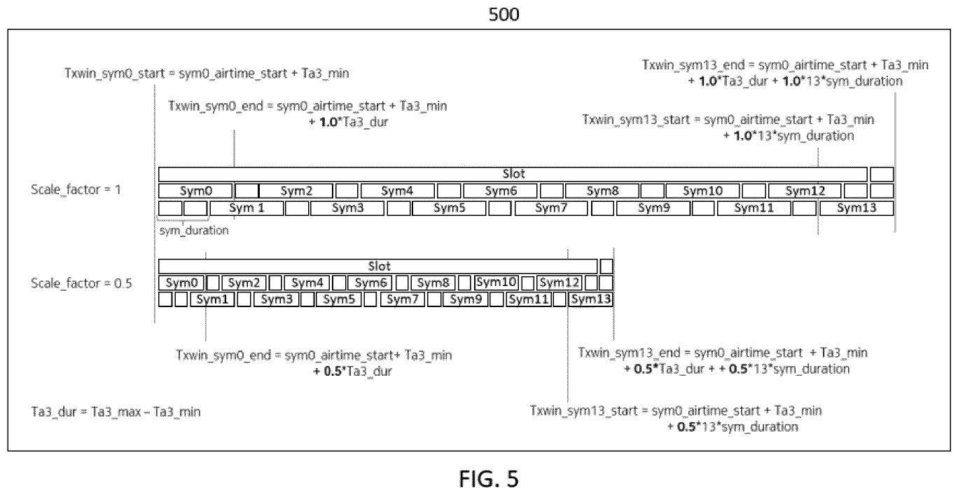

FIG. 5 illustrates an example 500 showing the impact of the transmission window scaling factor. The example illustrates the impact of applying a scaling factor of 0.5 compared to applying a scaling factor of 1.

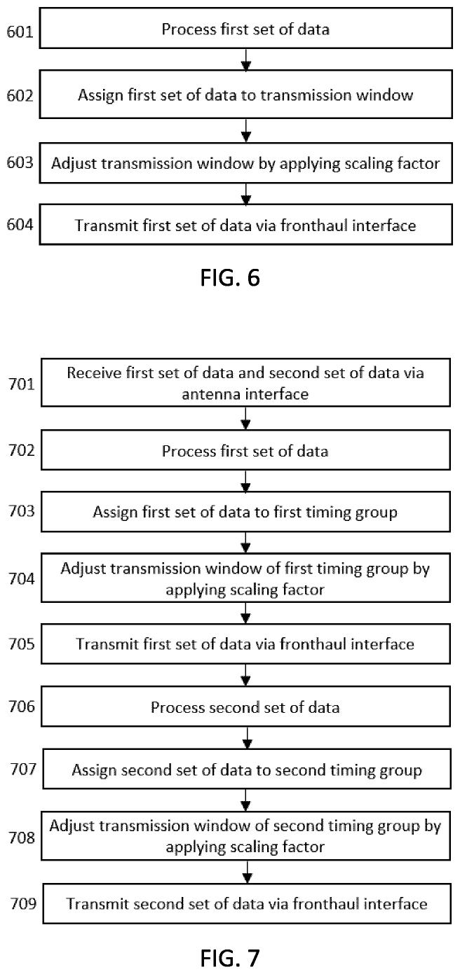

FIG. 6 illustrates a flow chart according to an exemplary embodiment, wherein fronthaul timing is scaled with a scaling factor that may be based for example on the air interface bandwidth, and slot gaps may be inserted between slots as needed. For example, a first timing group may cover a whole symbol for one cell, but with the scaling it can be sent out in half a slot, such that in a two-cell system a symbol for the second cell can be sent out during the remaining time. The scaling enables different symbols to experience different delays, for example the first symbol in the slot may have a high delay and later symbols may experience less delay. The transmission window scaling may be applied to all transmission windows in a given slot. The scaling may enable maintaining a symbol streaming approach with good control of timing data transfers, while still having flexibility for transferring data in a short amount of time, if available from the processing blocks in the radio unit.

Referring to FIG. 6, a first set of data is processed 601. For example, the processing may comprise at least performing channel estimation and/or interference rejection combining. The first set of data is assigned 602 to a transmission time window. The transmission time window is adjusted 603 by applying a scaling factor to the transmission time window. For example, the scaling factor may be a value between 0 and 1, and the scaling factor may be applied by multiplying the transmission time window by the scaling factor in order to reduce the transmission time window. As a non-limiting example, if the applied scaling factor is 0.5, then the adjusted transmission time window may be 50% shorter than the original transmission time window. The first set of data is transmitted 604 via a fronthaul interface during the adjusted transmission time window.

The mechanisms illustrated in FIGS. 4 and 6 may be operated separately, or they may be combined. FIG. 7 illustrates a flow chart according to an exemplary embodiment, wherein the two mechanisms are combined. Referring to FIG. 7, a first set of data and a second set of data are received 701 via an antenna interface. The first set of data is processed 702. For example, the processing may comprise at least performing channel estimation and/or interference rejection combining. The first set of data is assigned 703 to a first timing group comprising a first transmission time window. The first transmission time window is adjusted 704 by applying a first scaling factor to the first transmission time window. For example, the first scaling factor may be a value between 0 and 1, and the first scaling factor may be applied by multiplying the first transmission time window by the first scaling factor. The first set of data is transmitted 705 via a fronthaul interface during the adjusted first transmission time window. The second set of data is processed 706, wherein at least a part of the second set of data is processed during the first transmission time window. In other words, the first set of data is processed earlier than the second set of data and is thus available earlier, and the second set of data is still being processed when starting to transmit the first set of data. For example, the processing may comprise at least performing channel estimation and/or interference rejection combining. The second set of data is assigned 707 to a second timing group comprising a second transmission time window. The second transmission time window is adjusted 708 by applying a second scaling factor to the second transmission time window. For example, the second scaling factor may be a value between 0 and 1, and the second scaling factor may be applied by multiplying the second transmission time window by the second scaling factor. The value of the first scaling factor and the value of the second scaling factor may be substantially the same, or they may be different values. The second set of data is transmitted 709 via the fronthaul interface during the adjusted second transmission time window.

The functions described above by means of FIGS. 4, 6 and 7 may be performed by an apparatus such as a radio unit or an O-RU comprised in a base station.

The functions and/or blocks described above by means of FIGS. 4, 6 and 7 are in no absolute chronological order, and some of them may be performed simultaneously or in an order differing from the described one. Other functions and/or blocks may also be executed between them or within them.

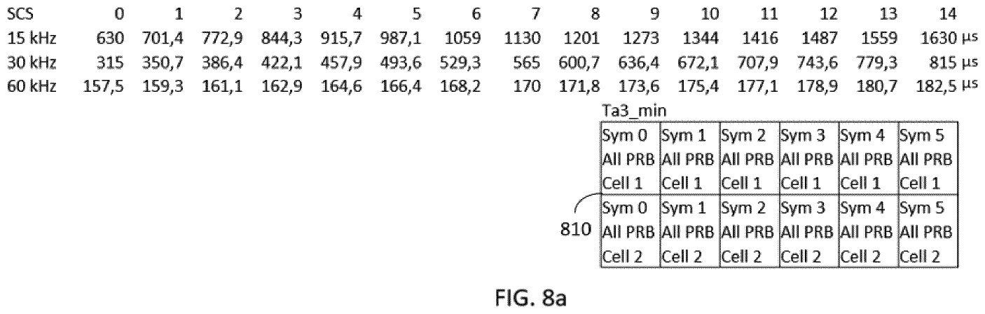

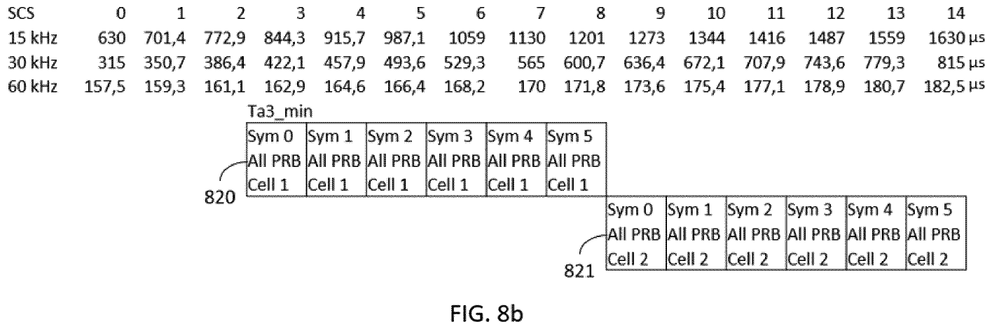

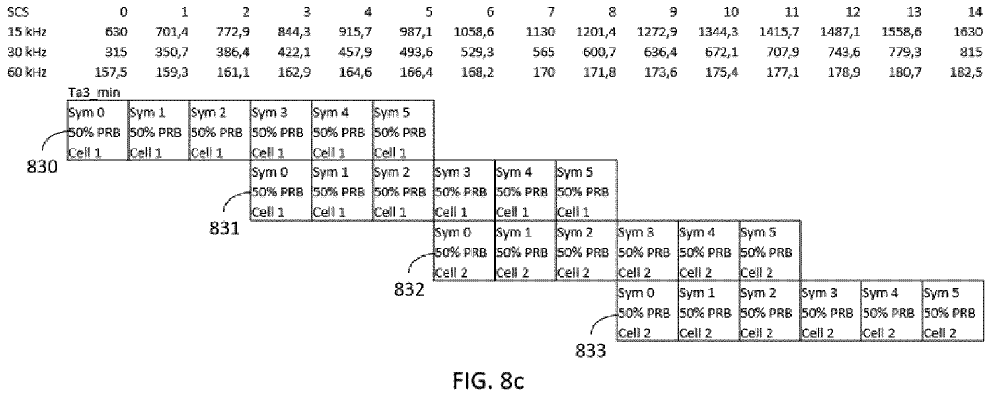

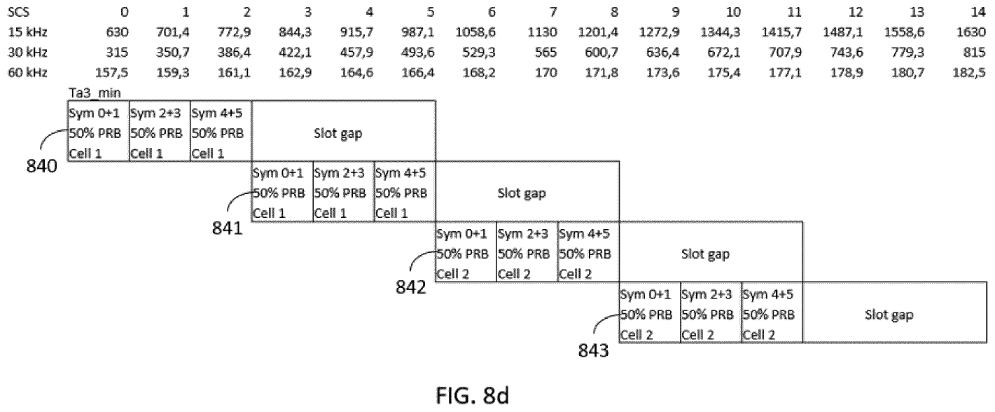

FIGS. 8a-8d illustrate examples of the fronthaul interface timing, for example the eCPRI timing, with respect to slot boundary air time, wherein the time values are in microseconds (μs). FIGS. 8a-8d illustrate how timing groups may be used to transfer an early part of the data for early processing in the system module. It should be noted that the number of symbols and the size of the time windows may vary from what is shown in FIGS. 8a-8d.

FIG. 8a illustrates an example comprising one timing group 810 with legacy O-RAN fronthaul timing. In this example, symbols are transmitted using 100% of the available PRBs.

FIG. 8b illustrates an example comprising two timing groups 820, 821 with carrier/cell-specific timing according to an exemplary embodiment. In this example, symbols are transmitted using 100% of the available PRBs.

FIG. 8c illustrates an example comprising four timing groups 830, 831, 832, 833 with carrier/cell-specific timing according to an exemplary embodiment. In this example, symbols are transmitted using 50% of the available PRBs.

FIG. 8d illustrates an example comprising four timing groups 840, 841, 842, 843 with carrier/cell-specific timing and a symbol scaling factor of 0.5 according to an exemplary embodiment. By applying a scaling factor of 0.5, two symbols are transmitted during a single slot. In this example, symbols are transmitted using 50% of the available PRBs.

In the exemplary embodiments illustrated in FIGS. 8b-8d, transmission from the RU may be started earlier than with the legacy O-RAN fronthaul timing illustrated in FIG. 8a. System module processing may speed up even further, since the data needed to start decoding is available earlier.

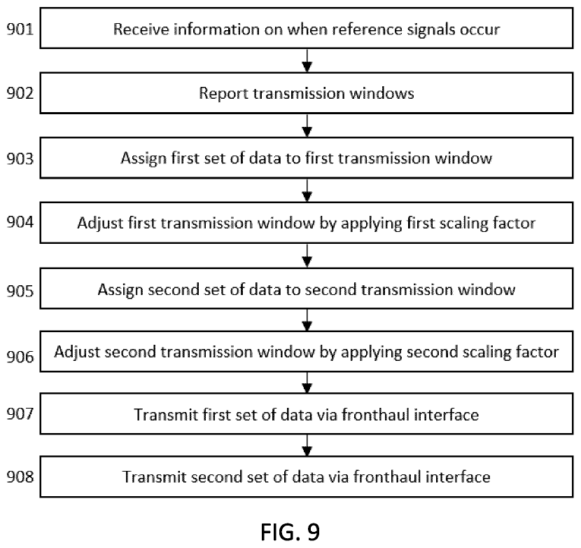

FIG. 9 illustrates a flow chart according to another exemplary embodiment, wherein different scaling factors are used for different symbols in a slot. The functions illustrated in FIG. 9 may be performed by an apparatus such as a radio unit or an O-RU comprised in a base station.

Referring to FIG. 9, the O-RU receives 901 information from an O-DU on when reference signals occur. The O-RU reports 902 back to the O-DU, for each eAxC, a table of up to 14 transmission windows, for example one for each symbol in a slot. The transmission windows are adjusted according to the O-RU's estimates of when processing of related reference signals will complete, and when a radio signal for a given symbol will be received and processed. A first set of data, i.e. a first symbol, is assigned 903 to a first transmission time window. The first transmission time window is adjusted 904 by applying a first scaling factor to the first transmission time window. A second set of data, i.e. a second symbol, is assigned 905 to a second transmission time window. The second transmission time window is adjusted 906 by applying a second scaling factor to the second transmission time window. The second scaling factor is different than the first scaling factor. The first set of data is transmitted 907 via a fronthaul interface during the adjusted first transmission time window. The second set of data is transmitted 908 via the fronthaul interface during the adjusted second transmission time window. The first transmission window and the second transmission window are comprised in the same time slot. In other words, the first symbol and the second symbol are comprised in the same slot.

The functions and/or blocks described above by means of FIG. 9 are in no absolute chronological order, and some of them may be performed simultaneously or in an order differing from the described one. Other functions and/or blocks may also be executed between them or within them.

A technical advantage provided by some exemplary embodiments is that they may improve system performance due to lower latency, and provide additional capacity by distributing processing to a larger time window. Some exemplary embodiments enable using different delay characteristics for different carriers, even if the bandwidth and subcarrier spacing of the carriers is substantially the same. Furthermore, some exemplary embodiments may enable having different service classes for the air interface. Some exemplary embodiments may enable the system module, such as the O-DU, to meet HARQ loop requirements for delivery of acknowledgements (ACK) and negative acknowledgements (NACK) to the L2 (layer 2) scheduler. Some exemplary embodiments may enable controlling the rate of data transfer over a fronthaul interface, thus resulting in a more flexible rate of data transfer. Moreover, some exemplary embodiments (where different scaling factors are applied to different symbols) may allow to minimize latencies, for example in cases when symbols with reference signals occur early in the slot, and time needed to process the reference signals in the O-RU is shorter than the slot duration.

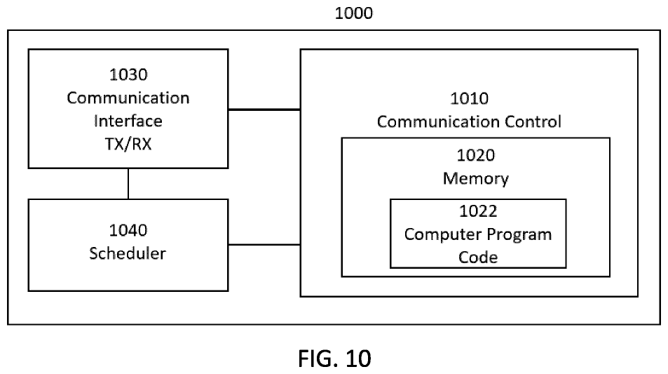

The apparatus 1000 of FIG. 10 illustrates an exemplary embodiment of an apparatus such as, or comprised in, a base station such as a gNB. The apparatus may comprise, for example, a circuitry or a chipset applicable to a base station to realize some of the described exemplary embodiments. The apparatus 1000 may be an electronic device comprising one or more electronic circuitries. The apparatus 1000 may comprise a communication control circuitry 1010 such as at least one processor, and at least one memory 1020 including a computer program code (software) 1022 wherein the at least one memory and the computer program code (software) 1022 are configured, with the at least one processor, to cause the apparatus 1000 to carry out some of the exemplary embodiments described above.

The memory 1020 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 1000 may further comprise a communication interface 1030 comprising hardware and/or software for realizing communication connectivity according to one or more communication protocols. The communication interface 1030 may provide the apparatus with radio communication capabilities to communicate in the cellular communication system. The communication interface may, for example, provide a radio interface to terminal devices. The apparatus 1000 may further comprise another interface towards a core network such as the network coordinator apparatus and/or to the access nodes of the cellular communication system. The apparatus 1000 may further comprise a scheduler 1040 that is configured to allocate resources.

As used in this application, the term “circuitry” may refer to one or more or all of the following:
a. hardware-only circuit implementations (such as implementations in only analog and/or digital circuitry) and
b. combinations of hardware circuits and software, such as (as applicable):
   i. a combination of analog and/or digital hardware circuit(s) with software/firmware and
   ii. any portions of hardware processor(s) with software (including digital signal processor(s)), software, and memory(ies) that work together to cause an apparatus, such as a mobile phone, to perform various functions) and
c. hardware circuit(s) and or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus comprising:
at least one processor; and
at least one memory including computer program code, wherein the at least one memory and the computer program code are configured, with the at least one processor, to cause the apparatus to:
process a first set of data;
assign the first set of data to a first timing group comprising a first transmission time window;
transmit the first set of data via a fronthaul interface during the first transmission time window;
process a second set of data, wherein at least a part of the second set of data is processed during the first transmission time window;
assign the second set of data to a second timing group comprising a second transmission time window; and
transmit the second set of data via the fronthaul interface during the second transmission time window.

2. The apparatus according to claim 1, wherein a first carrier is used for transmitting the first set of data and a second carrier is used for transmitting the second set of data, wherein the first carrier and the second carrier use a substantially same bandwidth and/or subcarrier spacing.

3. The apparatus according to claim 1, wherein the apparatus is further caused to:
indicate, via the fronthaul interface, a capability to use a plurality of timing groups, wherein the first timing group and the second timing group are comprised in the plurality of timing groups.

4. The apparatus according to claim 1, wherein the apparatus is further caused to:
adjust the first transmission time window and/or the second transmission time window by applying a scaling factor to the first transmission time window and/or to the second transmission time window.

5. The apparatus according to claim 1, wherein the processing comprises at least performing channel estimation and/or interference rejection combining.

6. The apparatus according to claim 1, wherein the fronthaul interface is an ethernet-based fronthaul interface.

7. The apparatus according to claim 1, wherein the apparatus comprises an open radio access network radio unit.

8. The apparatus according to claim 1, wherein the first set of data is associated with a first extended antenna-carrier assigned to the first timing group, and the second set of data is associated with a second extended antenna-carrier assigned to the second timing group.

9. An apparatus comprising:
at least one processor; and
at least one memory including computer program code, wherein the at least one memory and the computer program code are configured, with the at least one processor, to cause the apparatus to:
assign a first set of data to a first transmission time window;
adjust the first transmission time window by applying a first scaling factor to the first transmission time window; and
transmit the first set of data via a fronthaul interface during the adjusted first transmission time window.

10. The apparatus according to claim 9, wherein the first scaling factor is applied to a plurality of transmission time windows in a slot, wherein the first transmission time window is comprised in the plurality of transmission time windows.

11. The apparatus according to claim 9, wherein the apparatus is further caused to:
assign a second set of data to a second transmission time window;
adjust the second transmission time window by applying a second scaling factor to the second transmission time window; and
transmit the second set of data via the fronthaul interface during the adjusted second transmission time window;
wherein the first transmission time window and the second transmission time window are comprised in a single slot.

12. A method comprising:
processing a first set of data;
assigning the first set of data to a first timing group comprising a first transmission time window;
transmitting the first set of data via a fronthaul interface during the first transmission time window;
processing a second set of data, wherein at least a part of the second set of data is processed during the first transmission time window;
assigning the second set of data to a second timing group comprising a second transmission time window; and
transmitting the second set of data via the fronthaul interface during the second transmission time window.

13. The method according to claim 12, wherein a first carrier is used for transmitting the first set of data and a second carrier is used for transmitting the second set of data, wherein the first carrier and the second carrier use a substantially same bandwidth and/or subcarrier spacing.

14. The method according to claim 12, further comprising:
indicating, via the fronthaul interface, a capability to use a plurality of timing groups, wherein the first timing group and the second timing group are comprised in the plurality of timing groups.

15. The method according to claim 12, further comprising:
adjusting the first transmission time window and/or the second transmission time window by applying a scaling factor to the first transmission time window and/or to the second transmission time window.

16. The method according to claim 12,
wherein the processing comprises at least performing channel estimation and/or interference rejection combining.

17. The method according to claim 12, wherein the fronthaul interface is an ethernet-based fronthaul interface.

18. The method according to claim 12, wherein the first set of data is associated with a first extended antenna-carrier assigned to the first timing group, and the second set of data is associated with a second extended antenna-carrier assigned to the second timing group.

19. A method comprising:
assigning a first set of data to a first transmission time window;
adjusting the first transmission time window by applying a first scaling factor to the first transmission time window; and
transmitting the first set of data via a fronthaul interface during the adjusted first transmission time window.

20. The method according to claim 19, wherein the first scaling factor is applied to a plurality of transmission time windows in a slot, wherein the first transmission time window is comprised in the plurality of transmission time windows.

21. The method according to claim 19, further comprising:
assigning a second set of data to a second transmission time window;
adjusting the second transmission time window by applying a second scaling factor to the second transmission time window; and
transmitting the second set of data via the fronthaul interface during the adjusted second transmission time window;
wherein the first transmission time window and the second transmission time window are comprised in a single slot.

22. A non-transitory computer-readable medium including computer program instructions encoded thereon, said computer program instructions, when executed on an apparatus, cause the apparatus to perform the method according to claim 12.

23. A non-transitory computer-readable medium including computer program instructions encoded thereon, said computer program instructions, when executed on an apparatus, cause the apparatus to perform the method according to claim 19.

24.-31. (canceled)
